(19) United States
(12) Patent Application Publication
(10) Pub. No.: US 2008/0077966 A1
(43) Pub. Date: Mar. 27, 2008

(54) Method and Device for Recovering Information in Interactive Digital Tv Systems

(75) Inventor: Xavier Arques, Paris (FR)

Correspondence Address: OSHA LIANG L.L.P., 1221 MCKINNEY STREET, SUITE 2800, HOUSTON, TX, 77010, US

(73) Assignee: Thomson Licensing, Bouligne-Billancourt (FR)

(21) Appl. No.: 10/582,024

(22) PCT Filed: Dec. 6, 2004
(86) PCT No.: PCT/EP04/53289

§ 371 Date: Jul. 30, 2007

(30) Foreign Application Priority Data
Dec. 10, 2003 (EP) 03293103.2

(51) Int. Cl. H04N 7/173

(52) U.S. Cl. 725/114

(57) ABSTRACT

The method according to the invention is mainly implemented in terminal devices of an interactive digital TV system. The method comprises a step for storing in a cache memory of the terminal device information transported in a data stream of the system. The method also comprises a step consisting in searching, according to at least one predefined selection criterion, for requested information in at least one of the information carriers formed by the data stream and the cache memory. The method finds it preferred application in interactive digital TV systems compliant with the MPEG-DVB standards. Preferably, the information and/or MPEG tables are stored in the cache memory according to a structural organization similar to that of the information and/or MPEG tables in the data stream. The invention provides the application programs with optimal access to the MPEG tables and service information.

The present invention relates in a general manner to the recovery of information transmitted in an interactive digital TV system. More specifically the invention relates to the recovery of information transmitted for an application program running in a terminal device of an interactive digital TV system.

The present invention finds application mainly, but not exclusively, in the recovery of service information associated with television channels and interactive services incorporated in program packages transmitted by digital television systems.

In the rest of the description, the term “service”, in the context of a service transmitted to users or subscribers via an interactive digital television system, is used equally to mean a television channel and a service, whether interactive or not.

In the state of the art, digital television systems such as those defined by the various DVB (Digital Video Broadcast) and MPEG (Motion Picture Expert Group) standards developed respectively by the ETSI (European Telecommunications Standards Institute) and the ISO (International Organization for Standardization) are known.

It should be noted that the term “DVB” is used here to mean both 25 the DVB standards, such as DVB-S, DVB-C, DVB-T, etc, and their extension through the DVB-MHP (Multimedia Home Platform) standard. Also, the term “MPEG” refers here not only to the MPEG-2 and MPEG-4 standards, but also to their variants, modifications and developments applicable to digital data transmission including a DVB standard.

The digital television systems of the state of the art transmit, via transmission centres, digital information supporting various services, some of them interactive, to terminal devices. Compression, encoding and multiplexing techniques are employed together with other known techniques to form data streams, also called transport streams. The data streams carry the services transmitted to the terminal devices and the service information associated with these transmitted services.

The data streams are transmitted to the terminal devices conventionally through respective frequency channels with corresponding transponders located in one or more relay terminals. A relay terminal typically comprises a geostationary satellite equipped with as many transponders as there are frequency channels to be transmitted. The transponders handle the functions of receiving, regenerating/amplifying and retransmitting the frequency channels to the terminal devices.

To enable interactivity between a terminal device and the transmission centre, a return link to the transmission centre is provided either via the same transmission carrier as that through which the services are transmitted, or via a different carrier such as a telephone link.

The data streams each comprise a plurality of packets containing digital video, audio and text data, as well as service information.

The service information is transported in the form of tables. The tables are transmitted regularly and cyclically.

Depending on their nature, the tables are typically transmitted on all of the data streams of the channel package or specifically on the data streams conveying the services to which they are linked.

Each table is transmitted with a certain frequency, dependent on its nature, which should be sufficient to refresh the service information on the terminal devices.

Signalling tables, generically designated PSI/SI, and private tables, the content of which is defined by the operator of the digital television system, are provided by the MPEG-DVB standards.

The PSI/SI signalling tables comprise, for example:
the CAT table including ECM messages for controlling subscriber access to the digital television system and service decryption,
the SDT table relating to the services on a particular data stream,
the BAT table concerning the bundling of these services into packages,
the NIT table containing all the services of the operator which can be accessed by the users and providing the miscellaneous tuning information (frequency, polarization, FEC, etc) that is required by the terminal device for each of the services transmitted,
the EIT table providing information on current or future events, information that is used by the electronic program guide EPG,
and so on.

The private tables can be used to transport service information relating to the interactive services and typically comprise tables associated with telepurchasing or pay-per-view PPV transmissions.

A terminal device normally comprises either a combination of a set-top box and a conventional television receiver, or an integrated receiver decoder (IRD) handling reception, decoding and display functions.

The receiver/decoder device conventionally comprises a buffer memory in which the digital data extracted from the data stream is stored.

The interactive digital television systems of the prior art described above present a number of problems:
The tables transmitted cyclically represent a high bit rate and occupy a considerable percentage of the transmission frequency bandwidth of the system, to the detriment, for example, of the number of services offered to the users.
In a receiver/decoder device, the average time for an application program to access service information is associated with the transmission cycle frequency of the corresponding table. For service information contained in a table with low frequency, the access times can therefore be relatively long.
When a receiver/decoder device is tuned to a transponder of the system, to receive a service transmitted through a data stream associated with that transponder, the receiver/decoder device has access only to the tables included in that data stream. In a receiver/decoder device equipped with two tuners, the device can have access to more tables, but it is still limited in its accessibility to the service information. A wider accessibility to the service information is advantageous, for example, for displaying on the display screen of the terminal device information relating to services other than the current service.

Also from the prior art, the applicant knows of a device for transmitting and loading information designed to store in a non-volatile memory of a receiver/decoder device service information originating from a transmission centre of a digital television type communication system.

In this information transmission and loading device, there is a loading device for automatically loading the service information in the non-volatile memory, called a cache memory. Furthermore, a dedicated transponder can also be provided to transport all the service information of the system grouped together. In the receiver/decoder, accessibility to all the service information is thus possible through a single tuner tuned to the service transponder.

The automatic loading of the service information into the cache memory is triggered by a programmed timer, for example at night, or when a particular event occurs, such as the switching on of the receiver/decoder.

This information transmission and loading device represents a significant advance in the provision of a technical solution to the problems stated above in the prior art.

Additional improvements are, however, desirable in order to make progress, on the one hand, in reducing the bandwidth portion occupied by the service information and, on the other hand, in the provision of optimal accessibility to the information by the application programs.

The main object of the present invention is to add the desirable improvements indicated above to the prior art.

The present invention primarily aims to provide a method of recovering information in an interactive digital television system, in which information from a transmission centre is transported in a data stream to at least one terminal device in which one or more applications are running, the method comprising a step for loading and storing the information in storage means provided in the terminal device, characterized in that it furthermore comprises the following steps carried out in the terminal device:
a) reception of a request sent by at least one application to recover the information;
b) according to at least one predefined selection criterion, search for the information in at least one of the information carriers formed by the data stream, and the information storage means; and
c) if the search result is positive, recovery of the information from the information carrier containing the information and provision of the duly recovered information to at least one application sending the request

Correlatively, the invention also relates to an information recovery device in an interactive digital television system in which information originating from a transmission centre is transported in a data stream to at least one terminal device in which one or more applications are running, the terminal device being equipped with information storage means and means for loading the information into the information storage means, characterized in that it furthermore comprises:
means for receiving a request sent by at least one application to recover the information;
means for searching, according to at least one predefined selection criterion, for the information in at least one of the information carriers formed by the data stream, and the information storage means; and
means for recovering, in the case of a positive search result, the information from the information carrier containing the information and supplying the duly recovered information to at least one application sending the request.

According to a particular feature, the search comprises a search for the information in the storage means.

According to another particular feature, the search comprises a search for the information in the data stream.

According to yet another particular feature, the search comprises a search for the information in the storage means after an unsuccessful search in the data stream.

According to yet another particular feature, the search comprises a search for the information in the data stream after an unsuccessful search in the storage means.

According to a particular embodiment of the invention, a selection criterion is defined by the application.

According to another particular embodiment of the invention, a selection criterion is defined by an intermediate software layer and/or a hardware layer of the terminal device.

According to yet another particular embodiment of the invention, a selection criterion is defined by the interactive digital television system.

Preferably, the recovered information is formatted before being supplied to the application sending the request.

In the preferred, but not exclusive, application of the invention to the interactive digital television systems compliant with the MPEG-DVB standards, the information is encapsulated in at least one MPEG table identified by a respective table identifier. Furthermore, the search for the information comprises a search for the MPEG table from its respective table identifier whereas the recovery comprises recovery of the information from the duly identified MPEG table.

Preferably, the information and/or MPEG tables are stored in the storage means according to a structural organization similar to that of the information and/or MPEG tables in the data stream.

According to other aspects, the invention also relates to a receiver/decoder device, a terminal device and an interactive digital television system for implementing the method of the invention briefly described above.

Other aspects and advantages of the present invention will become more clearly apparent on reading the description of the particular embodiments which follows, this description being given purely as a non-limiting example and being made with reference to the appended drawings, in which:

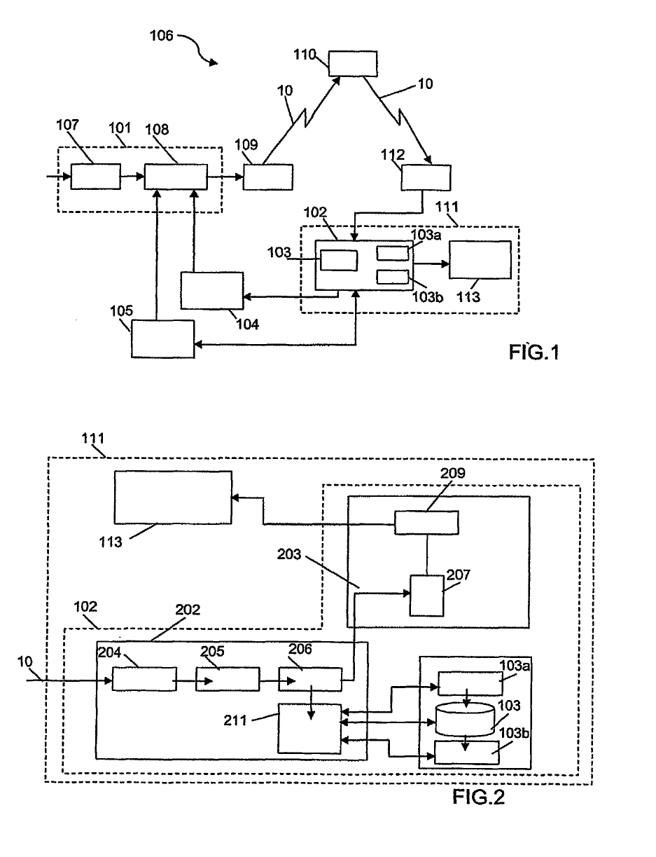

FIG. 1 diagrammatically shows an interactive digital television system according to the invention;

FIG. 2 diagrammatically shows the structure of a terminal device included in the system of FIG. 1;

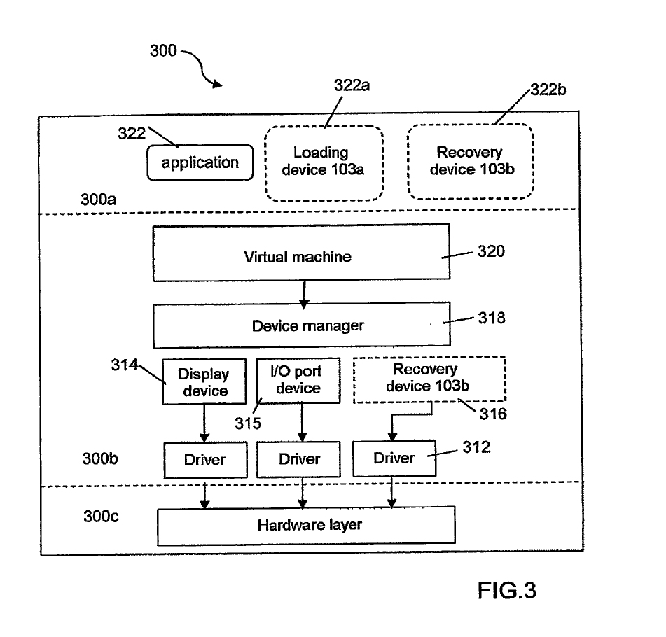

FIG. 3 diagrammatically shows the overall architecture of a receiver/decoder device included in the terminal device of FIG. 2;

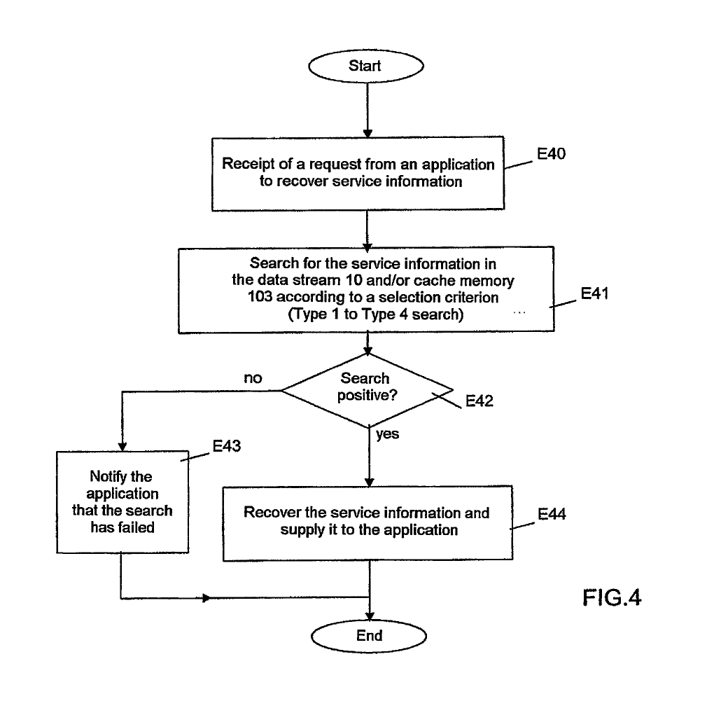

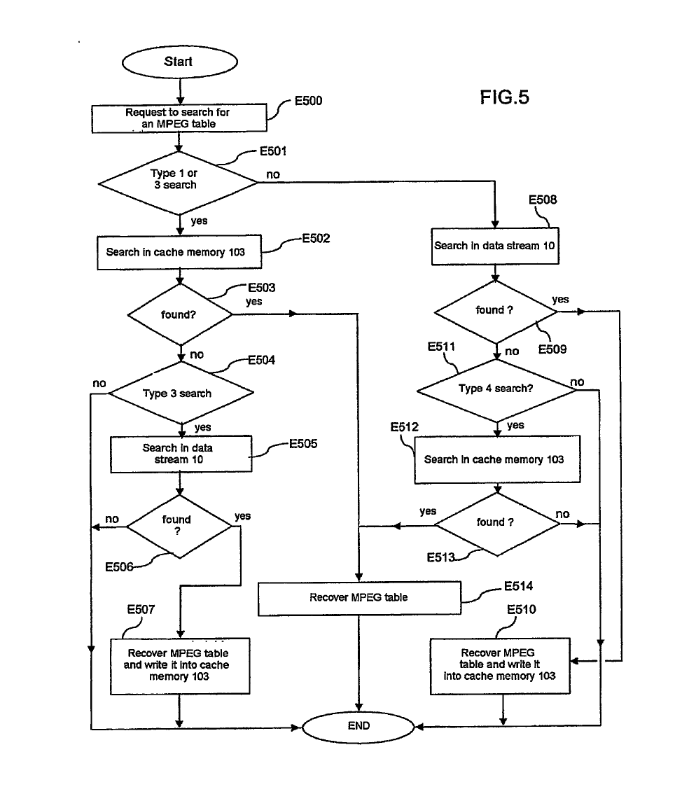

FIG. 4 shows a general algorithm of the information recovery method according to the invention;

FIG. 5 shows a detailed algorithm of a search step in the method according to the invention; and

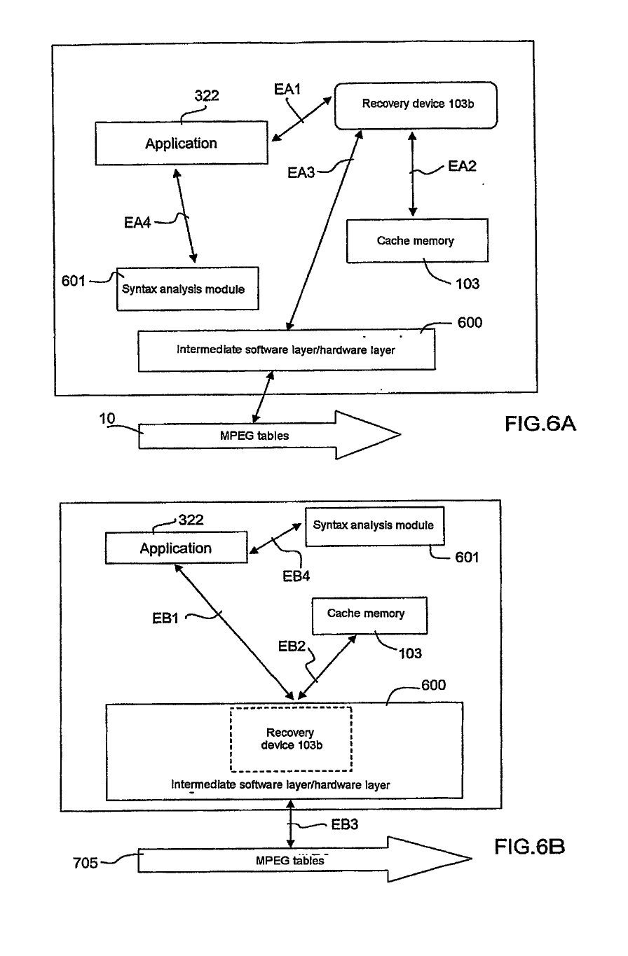

FIGS. 6A and 6B are simplified representations of the functional steps respectively in an embodiment of the receiver/decoder device according to the invention in which the recovery of information is managed in an application layer and in another embodiment of the receiver/decoder device according to the invention in which the recovery of information is managed in an intermediate software layer/hardware layer.

Referring to FIG. 1, an interactive digital television system 106 comprises a transmission centre 101 and at least one terminal device 111 belonging to an installed base of terminal devices.

The terminal device 111 comprises a receiver/decoder device 102 and a display unit 113.

The receiver/decoder device 102 has a hardware and/or software architecture in particular including a non-volatile memory 103, called cache memory, typically in the form of a hard disk, and an automatic loading device 103a.

According to the invention, the receiver/decoder device 102 also comprises an information recovery device 103b implementing the method of the invention.

The digital television system 106 furthermore comprises on the one hand an interactive device 104 serving as a return channel and, on the other hand, a conditional access system 105.

As a general rule, the digital television system 106 uses an MPEG type compression system to transmit compressed digital signals.

In the transmission centre 101, a compressor unit 107 receives a digital stream, typically a stream of audio and/or video signals, and converts this stream into digital signals in MPEG format

The compressor unit 107 is connected by a link to a multiplexer and scrambler forming unit 108.

The multiplexer and scrambler forming unit 108 receives a plurality of converted feeds and/or data (application and application data), collates these feeds and/or data into a single channel, and transmits the compressed digital streams to a transmitter (modulator/transmit dish) 109 of the transmission centre 101.

The transmitter 109 transmits the data streams 10 via a first link (satellite, terrestrial, cable, combination of both or several transmission means) to a relay terminal 110 which retransmits them via a second link to the receivers 112, for example, via dishes or antennas. The relay terminal 110 is, for example, a satellite equipped with a certain number of transponders to handle the reception, regeneration/amplification and retransmission of the various frequency channels supporting the data streams 10.

The signals received by the receivers (antennas) 112 are transmitted to the receiver/decoder device 102 of the terminal device 111 of the user, to which is connected a display unit 113, such as a television set.

The receiver/decoder device 102 filters a portion of the global data stream corresponding to the service expected by the user.

Then, the receiver/decoder device 102 decodes the compressed MPEG signal into a video or other data stream for the display unit 113.

The interactive device 104 is connected to the multiplexer and scrambler forming unit 108 on the one hand, and to the receiver/decoder device 102 on the other hand. In practice, the interactive device 104 is partially located in the transmission centre 101 and partially in the terminal device 111. The interactive device 104 enables the user to interact with a certain number of applications via a return channel. The channel, or return channel, can be, for example, a PSTN (Public Switched Telephone Network) type communication channel or a GPRS or UMTS type mobile communication channel.

The conditional access system 105 is also connected to the multiplexer and scrambler forming unit 108 and to the receiver/decoder device 102. The conditional access system 105 is also located partly in the transmission centre 101 and partly in the receiver/decoder device 102. The conditional access system 105 enables the user to access the services to which he has taken out a subscription, typically television channels.

The conditional access system is based on a chip card held by the user. The chip card is capable of decrypting the messages relating to the commercial offerings. The chip card communicates with a chip card reader (not shown) installed in the receiver/decoder device 102.

In practice, some of the services transmitted by the transmission centre 101 are encoded, the encryption conditions and keys applied to a transmission being determined by the access control system.

As a general rule, the encoded data is transmitted with a control word for decoding the data.

The control word is itself encrypted by an operation key and transmitted in encrypted form.

The encoded data and the encrypted control word are received by the receiver/decoder device 102 having access to the operation key stored in the chip card inserted in the receiver/decoder device 102 to decrypt the encrypted control word and then decode the transmitted data.

Referring to FIG. 2, the structure of the terminal device 111 comprises a receiver/decoder device 102 having a receiver-forming part 202 and a decoder-forming part 203. The terminal device 111 receives the data stream 10 transmitted by the transmission centre 101. The decoder-forming part 203 comprises a buffer memory 207 and a processing unit 209 communicating with a display unit 113.

The receiver-forming part 202 comprises at least one reception subsystem formed by a tuner 204, a demodulator 205 and a demultiplexer 206. The demultiplexer 206 separates the different data transmitted in the data stream 10 and supplies, on the one hand, the service information to a service information processing unit 211 and, on the other hand, the audio/visual data to the buffer memory 207 for writing into the latter.

The data in the buffer memory 207 is then read by the processing unit 209 which descrambles the service received, if the latter is scrambled, and if the user has the corresponding access rights.

The result of the processing is then routed to the display unit 113.

The function of the service information processing unit 211 is to process all of the service information. The unit 211 can order the service information in the cache memory 103 to be stored in non-volatile memory.

The automatic loading device 103a cooperates with the service information processing unit 211 to automatically order service information to be loaded into the cache memory 103. This automatic loading command can be triggered by a programmed timer, for example at night, or when a particular event occurs, such as the switching on of the receiver/decoder device 102. When the automatic loading command is triggered, the automatic loading device 103a causes the tuner 204 to be tuned, for example, to the frequency of a service transponder of the transmission centre 101 via which all the service information is transmitted.

The information recovery device 103b cooperates with the service information processing unit 211 to recover service information by reading from the cache memory 103 or by extraction from the data stream 10 received by the tuner 204.

The buffer memory 207 is a temporary memory which is designed to contain all the information needed to enable the decoder-forming part 203 to reconstruct the signal to be displayed.

As a variant, a terminal device can comprise two reception subsystems, each comprising a tuner, a demodulator and a demultiplexer. Such a receiver/decoder device with two reception subsystems can thus be used to store a first data stream on a first reception subsystem and, at the same time, display a second data stream from the second reception subsystem.

Referring to FIG. 3, the overall architecture of the platform 300 containing the receiver/decoder device comprises three layers, namely, an application layer 300a, an intermediate software layer 300b and a hardware layer 300c.

The application layer 300a supplies the functionalities of the applications run by the platform on a receiver/decoder device.

This application layer 300a is controlled by service provider devices.

An application 322 can:
be resident or be loaded dynamically into the receiver/decoder device;
be run independently or in conjunction with the audio/video/data stream of one or more television services; and/or
make requests to servers via a return channel and display the responses on the display screen.

The automatic loading device 103a is, for example, produced using an application type program 322a located in the application layer 300a.

According to a particular embodiment of the invention, the information recovery device 103b is produced using an application type program 322b located in the application layer 300a.

According to another particular embodiment of the invention, the information recovery device 103b is produced using a program 316 located in the intermediate software layer 300b.

The platform 300 also comprises, in its intermediate software layer 300b, a virtual machine 320 providing an intermediate code interpreter, a storage medium and various processing directories.

The platform 300 furthermore comprises a device manager 318 and corresponding devices, in other words, for example, a display device 314, an input/output device 315 and the information recovery device 103b (316).

Referring more specifically to FIGS. 4, 5, 6A and 6B, the operation of the receiver/decoder device 102 equipped with the information recovery system 103b implementing the information recovery method according to the invention is now described.

The automatic loading of the MPEG tables in the cache memory 103 by the automatic loading device 103a was described in the introduction, in the explanation of the state of the art, and will not be described in detail here.

As FIG. 4 shows, the general algorithm of the information recovery method according to the invention comprises the following main steps E40 to E44.

In the step E40, a request is received from an application 322 for the recovery of service information directly from the data stream 10 or from the cache memory 103.

The step E41 is provided to search for the requested service information in the data stream 10 and/or in the cache memory 103.

According to the invention, the search performed in step E41 can be of various types. The type of search selected depends on one or more selection criteria.

The various search types are:
Type 1) a search from the cache memory 103 only;
Type 2) a search from the data stream 10 only;
Type 3) a search from the cache memory 103 and then from the data stream 10, if appropriate, in other words, if the information sought has not been found in the cache memory 103;
Type 4) a search from the data stream 10 and then from the cache memory 103, if appropriate, in other words, if the information sought has not been found in the data stream 10.

According to the invention, the or each selection criterion can be defined and/or managed locally by the application or by the intermediate 1 5 software layer/hardware layer, or centrally by the interactive digital television system.

The selection criteria can take into account elements such as the nature of the service information required, how critical the service information is to the application, in terms, for example, of access time, information refresh time, and so on, and all other elements that a person skilled in the art would consider important to take into account.

When a selection criterion is managed by the application, the latter is then able to define for itself the type of search to be applied to recover the service information.

The step E42 is a conditional step leading to the execution of the step E43 or the step E44.

When the result of the search in the step E41 is negative, in other words, when the requested service information is not found, the step E43 is executed to notify the application that the search has failed.

When the result of the search in the step E41 is positive, in other words, when the requested service information is found, the step E44 is executed to recover the requested service information and supply it to the application.

Referring more specifically to FIG. 5, an example of algorithm employed in the search step E41 of the method according to the invention is now described in greater detail.

This algorithm deals with the search for an MPEG table in which the requested service information is encapsulated.

As FIG. 5 shows, the algorithm comprises the steps E500 to E514.

In the step E500, an application 322 makes a request to search for an MPEG table.

In this step E500, the type of search required is defined using selection criteria. A type, Type 1 to Type 4, is assigned to the search to be carried out.

The function of the step E601 is to determine whether the requested search is Type 1 or Type 3.

The step E501 is a conditional step leading to the execution of the step E502 or the step E508.

In the affirmative, in other words, if the requested search is Type 1 or 3, the step E502 is executed.

The step E502 consists in performing a search in the cache memory 103. The processing performed by the algorithm after the step E502 depends on the success or failure of the search in the cache memory 103.

The conditional step E503 analyses the result of the search performed in the step E502.

If the MPEG table sought is actually found in the cache memory 103 in the step E502, the step E514 is then executed.

The step E514 concerns the recovery of the MPEG table and the extraction of the requested service information for delivery to the application 322 having made the request.

If the MPEG table requested in the step E500 is not found in the cache memory 103 in the step E502, the step E504 determines whether the search is Type 3.

If not, in other words, if the search is not Type 3, the algorithm is ended.

If it is, the step E505 carries out a search on the data stream 10.

A step E506 is then provided to analyse the search performed in the step E505.

The step E506 is a conditional step leading to the end of the algorithm or to the execution of the step E507.

If the MPEG table is not found in the data stream 10 in the step E505, the algorithm is ended.

Otherwise, in the step E507, the MPEG table is recovered from the data stream 10, is written into the cache memory 103 and the requested service information is then extracted for delivery to the application 322 having made the request.

Referring again to the step E501 of the algorithm, when the step E501 determines that the requested search is not Type 1 or 3, the step E508 is then executed.

In the step E508, the MPEG table is sought in the data stream 10.

The result of the search in the step E508 is analysed by the conditional step E509.

When the MPEG table sought is found in the data stream 10, the step E510 is carried out.

The step E510 is similar to the step E507 and consists in recovering the MPEG table from the data stream 10, writing it into the cache memory 103 and extracting the requested service information to then deliver it to the application 322.

Otherwise, in other words when the MPEG table is not found in the data stream 10 in the step E508, the step E511 is carried out.

The step E511 is a conditional step leading to the end of the algorithm or to the execution of the step E512.

The step E511 determines whether the search requested in the step E500 is Type 4.

If not, in other words, when the search is not Type 4, the algorithm is ended.

If it is, in other words, when the search is Type 4, the step E512 is carried out in which the MPEG table is sought in the cache memory 103.

The result of the step E512 is analysed by the conditional step E513.

In the step E513, when the MPEG table is found in the cache memory 103 in the step E512, the step E514 is then executed to recover the MPEG table from the cache memory 103 and extract the requested service information to deliver it to the application 322.

Otherwise, in other words, when the MPEG table is not found in the cache memory 103, the algorithm is ended.

Referring to FIGS. 6A and 6B, the main functional steps in the receiver/decoder device 102 between functional elements involved in the recovery of service information encapsulated in an MPEG table are now described in detail.

FIG. 6A more specifically relates to an embodiment of the invention in which the recovery of information is managed in the application layer 300a (FIG. 3).

As shown in FIG. 6A, the recovery of the MPEG tables in this embodiment of the invention involves the steps EA1 to EA4 taking place between the application 322, the information recovery device 103b, the cache memory 103, the intermediate software layer/hardware layer 600 (layers 300b and 300c of FIG. 3), the data stream 10 and a syntax analysis module 601, called a parser.

In the step EA1, the application 322 asks the information recovery device 103b to recover service information from an MPEG table.

In the steps EA2 and EA3, the information recovery device 103b recovers the corresponding MPEG table from the cache memory 103 or from the data stream 10 depending on the type, Type 1 to Type 4, of the search carried out. The recovery of the corresponding MPEG table from the data stream 10 is performed via the intermediate software layer/hardware layer 600.

In the step EA4, the syntax analysis module 801 extracts the requested service information from the recovered MPEG table and formats it for delivery to the application 322.

FIG. 6B more specifically relates to an embodiment of the invention in which the recovery of information is managed in the intermediate software layer/hardware layer 600.

As shown in FIG. 6B, the recovery of the MPEG tables in this embodiment of the invention involves the steps EB1 to EB4 taking place between the application 322, the information recovery device 103b, the cache memory 103, the intermediate software layer/hardware layer 600, the data stream 10 and the syntax analysis module 601.

In the step EB1, the application 322 asks the information recovery device 103b to recover service information from an MPEG table.

The request from the application 322 is transmitted to the intermediate software layer/hardware layer 600 for the information recovery device 103b.

In the steps EB2 and EB3, the information recovery device 103b recovers the corresponding MPEG table from the cache memory 103 or from the data stream 10 according to the type, Type 1 to Type 4, of the search carried out.

In the step EB4, the syntax analysis module 601 extracts the requested service information from the recovered MPEG table and formats the latter for delivery to the application 322.

The embodiment of the invention that has just been described above with reference to FIG. 6B offers the advantage of processing which can be totally transparent to the application 322. In practice, the application 322 can simply transmit only its information recovery request to the intermediate software layer/hardware layer 600, as in a conventional receiver/decoder, the information recovery device 103b being responsible for managing the search type and the recovery of information according to the selection criteria.

A particular structural organization, characteristic of the present invention, for the storage of service information and MPEG tables in the cache memory 103, is now described through an example.

The structural organization of the service information and MPEG tables according to the invention is a tree-structure and roughly reflects the structure existing in a data stream and an interactive digital television system compliant with the MPEG-DVB standards. It is thus possible to have information recovery processing transparent to the application 322, because the same identifiers are used to recover an MPEG table from the data stream 10 or from the cache memory 103.

An interactive digital television system compliant with the MPEG-DVB standards comprises a certain number of transport streams TS, corresponding to the data streams 10 of the above description.

Each transport stream TS comprises a set of individual flows in the form of packets with corresponding identifiers PID.

The packets can contain audio, video and text data, as well as service information, which is encapsulated in MPEG data sections. The service information is also encapsulated in MPEG tables comprising one or more MPEG data sections.

In one and the same packet PID, there can be a number of MPEG tables which are differentiated from each other by unique identifiers. The identifier of an MPEG table comprises a mandatory portion TID (Table Identifier) and an optional extension portion TIDExt (Table Identifier Extension).

An MPEG table comprises a header followed by at least one MPEG data section. The header is chosen to be of long or short type depending on the size of the MPEG table.

A small size MPEG table (less than 1 Kbytes of data) comprises a short header and a single MPEG data section. The short header comprises an identifier TID and information representing the length of the MPEG section.

A larger size MPEG table (more than 1 Kbytes of data) comprises a long header and a number of MPEG data sections. The long header comprises the identifier TID and the extension TIDExt, information relating to the MPEG sections included such as the length and number of the MPEG sections, and other information.

A typical structural organization of the service information and MPEG tables according to the invention is as follows:

```
Network_Id = Identifier of the TV system or network
      TS_Id 1 = Identifier of frequency 1
            PID 1 = Identifier of packet 1
                  TID A = Identifier of MPEG Table A
                  TID B = Identifier of MPEG Table B
            PID 2 = Identifier of packet 2
                  TID C = Identifier of MPEG Table C
                  TID D = Identifier of MPEG Table D
                  ...
            PID n = Identifier of packet n
                  TID E = Identifier of MPEG Table E
      TS_Id 2 = Identifier of frequency 2
            PID 1 = Identifier of packet 1
                  TID A = Identifier of MPEG Table A
                  TID B = Identifier of MPEG Table B
            PID 2 = Identifier of packet 2
                  TID C = Identifier of MPEG Table C
                  TID D = Identifier of MPEG Table D
            PID 3 = Identifier of packet 3
                  TID F = Identifier of MPEG Table F
                  TID G = Identifier of MPEG Table G
                  ...
            PID m = Identifier of packet m
                  TID H = Identifier of MPEG Table H
                  ...
```

In a receiver/decoder device compliant with the MPEG-DVB standards, the services are identified by three elements:
the identifier of the digital TV system (Network_Id);
the identifier of the transport stream TS enabling the receiver/decoder device to be tuned to the corresponding frequency (TS_Id); and
the identifier of the service (Service_Id).

When an interactive application needs to recover service information from an MPEG table present on the current transport stream TS, it has for this the MPEG table identifier TID, the packet identifier PID and, where appropriate, the identifier TIDExt.

The information recovery device 103b according to the invention therefore has all the identifiers needed to determine whether the MPEG table sought is present in the cache memory 103.

Naturally, the present invention is not limited to the details of the particular embodiments described here by way of example, but can be extended to include modifications within the scope of a person skilled in the art, without departing from the spirit of the invention.

1. Method of recovering information in an interactive digital television system, in which information from a transmission centre is transported in a data stream to at least one terminal device in which one or more applications are running, the method comprising:
a step of loading and storing the information in a memory provided in the terminal device,
a step of receiving from the at least one application a request to recover the information;
a step of recovering of the information from an information carrier containing the information and provision of the duly recovered information to the at least one application sending the request; and
of searching for the information, according to at least one predefined selection criterion, in at least one of the information carriers formed by the data stream, and the memory.

2. The method as claimed in claim 1, wherein the search step comprises the sub-step of:
searching for the information in the memory.

3. The method as claimed in claim 1, wherein the search step comprises the sub-step of:
searching for the information in the data stream.

4. The method as claimed in claim 1, wherein the search step comprises the following sub-step of:
searching for the information in the memory after an unsuccessful search in the data stream.

5. The method as claimed in claim 1, wherein the search step comprises the sub-step of:
searching for the information in the data stream after an unsuccessful search in the memory.

6. The method as claimed in claim 1, wherein the information is encapsulated in at least one MPEG table identified by a respective table identifier.

7. The method as claimed in claim 6, wherein the search step comprises the sub-step of searching for the MPEG table from its respective table identifier whereas the recovery step comprises the sub-step of recovering the information from the duly identified MPEG table.

8. The method as claimed in claim 1, further comprising the step of defining at least one the selection criterion by the application.

9. The method as claimed in claim 1, further comprising the step of defining at least one the selection criterion by an intermediate software layer and/or a hardware layer of the terminal device.

10. The method as claimed in claim 1, further comprising the step of defining at least one the selection criterion by the interactive digital television system.

11. The method as claimed in claim 6, further comprising the step of storing the information and/or MPEG tables in the memory according to a structural organization similar to that of the information and/or MPEG tables in the data stream.

12. The method as claimed in claim 1, further comprising the step of formatting the recovered information before supplying the latter to the at least one application sending the request.

13. Information recovery device in an interactive digital television system in which information originating from a transmission centre is transported in a data stream to at least one terminal device in which one or more applications are running, the terminal device being equipped with:
an information memory,
means for loading the information into the information memory,
means for receiving a request sent by at least one the application to recover the information;
means for recovering the information from an information carrier containing the information and supplying the duly recovered information to the at least one application sending the request; and
means for searching, according to at least one predefined selection criterion, for the information in at least one of the information carriers formed by the data stream and the information memory.

14. The device as claimed in claim 13, wherein the search means comprise first additional means for searching for the information in the memory.

15. The device as claimed in claim 13, wherein the search means comprise second additional means for searching for the information in the data stream.

16. The device as claimed in claim 13, wherein the search means comprise third additional means for searching for the information in the memory after an unsuccessful search in the data stream.

17. The device as claimed in claim 13, wherein the search means comprise fourth additional means for searching for the information in the data stream after an unsuccessful search in the memory.

18. The device as claimed in claim 13, wherein the information is encapsulated in at least one MPEG table identified by a respective table identifier.

19. The device as claimed in claim 18, wherein the search means comprise fifth additional means for searching for the MPEG table from its respective table identifier whereas the recovery means comprise additional means for recovering the information from the duly identified MPEG table.

20. The device as claimed in claim 13, further comprising first means for defining at least one the selection criterion by the application.

21. The device as claimed in claim 13, further comprising second means for defining at least one the selection criterion by an intermediate software layer and/or a hardware layer of the terminal device.

22. The device as claimed in claim 13, further comprising third means for defining at least one the selection criterion by the interactive digital television system.

23. The device as claimed in claim 13, wherein the memory comprises additional means for storing the information and/or MPEG tables according to a structural organization similar to that of the information and/or MPEG tables in the data stream.

24. The device as claimed in claim 13, further comprising means for formatting the recovered information before supplying it to the at least one application sending the request.

25. Receiver/decoder device in an interactive digital television system, comprising means suited to implementation of the information recovery method according to claim 1.

26. Receiver/decoder device in an interactive digital television system, comprising an information recovery device according to claim 13.

27. Terminal device in an interactive digital television system, comprising a receiver/decoder device according to claim 25.

28. Interactive digital television system, comprising at least one receiver/decoder device according to claim 25.

29. Interactive digital television system, comprising at least one terminal device according to claim 27.

30. Terminal device in an interactive digital television system, comprising a receiver/decoder device according to claim 26.

31. Interactive digital television system, comprising at least one receiver/decoder device according to claim 26.
